(19) United States
(12) Patent Application Publication
(10) Pub. No.: US 2011/0177898 A1
(43) Pub. Date: Jul. 21, 2011

(54) SPROCKET AND ROTOR COVERS

(76) Inventor: Daniel Haydon, Louisville, KY (US)

(21) Appl. No.: 13/008,536

(22) Filed: Jan. 18, 2011

Related U.S. Application Data
(60) Provisional application No. 61/295,337, filed on Jan. 15, 2010.

(51) Int. Cl. B62J 13/00; B23P 11/00; B23P 6/00

(52) U.S. Cl. 474/144; 29/426.2; 29/402.08

(57) ABSTRACT

A sprocket and rotor cover is provided that includes a hollow annular structure having a substantially U-shaped cross-section along any portion of the structure and having an outer surface, an inner surface, and a pair of inner circumferential edges defining a centrally-disposed opening of the hollow annular structure. The sprocket and rotor cover further includes an annular receiving cavity that is defined between the inner surface of the hollow annular structure and that has a shape adapted to fit around a sprocket or a rotor. Methods of using the sprocket and rotor covers to change a sprocket or tire on a motorcycle are also provided.

### RELATED APPLICATIONS

This application claims priority from U.S. Provisional Application Ser. No. 61/295,337, filed Jan. 15, 2010, the entire disclosure of which is incorporated herein by this reference.

### TECHNICAL FIELD

The presently-disclosed subject matter relates to sprocket and rotor covers, as well as methods of using the same for changing a sprocket or tire of a motorcycle. In particular, the presently-disclosed subject matter relates to sprocket and rotor covers, and methods of using the same, where the sprocket and rotor covers include a hollow annular structure and an annular receiving cavity that has a shape adapted to fit around a sprocket or rotor.

### BACKGROUND

Many problems and difficulties can arise when changing a sprocket or tire on a motorcycle and, in particular, motorcycles that are used in motocross. For example, maintaining a motorcycle typically requires the use of a locktight adhesive on the nuts and bolts of a sprocket, which prevents the nuts and bolts from becoming inadvertently loosened, but also makes them difficult to remove. Thus, when an individual attempts to change a sprocket on a motorcycle, the individual frequently injures their knuckles or hands on the sprocket when they attempt to loosen the nut or bolts.

Injuries to an individual's knuckles or other portions of their hands also occur when an individual changes a tire on a motorcycle. When changing a tire on a motorcycle, many individuals frequently utilize one or more tire tools (e.g., levers) to pry the tires from the rim of the motorcycle wheels. These tire tools often slip, however, resulting in the individual hitting and injuring their knuckles or other portions of their hands on the rotor or sprocket of the motorcycle.

In changing a tire on a motorcycle, damage can also occur to the sprockets and rotors of the motorcycles themselves. In this regard, individuals typically change a tire on a motorcycle with the motorcycle wheel and, consequently, the sprocket or rotor lying face down on the ground. Laying the wheel face down on the ground, however, subsequently allows for the sprocket or rotor to be scratched or otherwise damaged when force is applied in order to change the tire. Individuals have attempted to overcome this problem by first placing a towel or other similar object on the ground prior to placing the motorcycle wheel on the ground. Nevertheless, damage to the sprocket or rotor still frequently occurs.

Furthermore, damage to sprockets or rotors can also occur by using tire tools to change the tire. Usually, when changing a tire, one tire tool is positioned under the sprocket or rotor, while another tire tool is utilized to pry the tire from the rim. Doing so, however, can allow the tire tool positioned under the sprocket or rotor to scratch or damage the sprocket or rotor.

Finally, it is also the case that damage to sprockets or rotors can occur when wheels of motorcycles are placed into storage. Generally, these stored wheels are kept in a garage or trailer, and are frequently stacked on top of one another to save space. This storage of motorcycle wheels can allow dust and debris to build up on the sprocket and rotors, and may also allow the sprockets and rotors to rub against and damage each other if the wheels are stacked on top of one another.

In any event, many problems and difficulties can arise in not only changing tires and sprockets on a motorcycle, but also in storing motorcycle wheels. To date, a sufficient cover for sprockets and rotors has yet to be provided that protects the sprockets and rotors from damage, but also protects an individual's hands from damage when changing a sprocket or tire on a motorcycle.

### SUMMARY

The presently-disclosed subject matter relates to sprocket and rotor covers for motorcycles, as well as methods of using the same for changing a tire or sprocket on a motorcycle, where the sprocket and rotor covers are advantageously used to prevent or reduce the problems and difficulties that arise with those tasks.

In some embodiments, an exemplary sprocket and rotor cover is comprised of a hollow annular structure having an outer surface, an inner surface, and a pair of inner circumferential edges that define a centrally-disposed opening of the hollow annular structure. The sprocket and rotor cover further includes an annular receiving cavity that is defined between the inner surface of the hollow annular structure. In some embodiments, the cross-section of the sprocket and rotor cover has a substantially U-shaped cross-section along any portion of the structure such that the annular receiving cavity has a shape adapted to fit around a sprocket or a rotor.

As a further refinement, in some embodiments of the presently-disclosed sprocket and rotor covers, the inner surface of the hollow annular structure comprises one or more notches for receiving the teeth of the sprocket. In certain embodiments, the one or more notches comprise a continuous groove extending around the circumference of the inner surface of the hollow annular structure. In other embodiments, the one or more notches comprise a plurality of discrete notches that extend around the circumference of the inner surface of the hollow annular structure. Each discrete notch is typically spaced at a predetermined distance from each adjacent notch such that each individual tooth of a particular sprocket can fit into a single discrete notch. In some embodiments, the outer circumferential edge of the outer surface of the hollow annular structure further includes a plurality of ridges that extend around the outer circumferential edge. In some embodiments, those ridges are positioned such that the position of each ridge corresponds to the position of each discrete notch.

As an additional refinement, in some embodiments of the presently-disclosed sprocket and rotor covers, the sprocket and rotor covers further comprise a disc that is positioned such that the disc covers one side of the centrally-disposed opening of the sprocket and rotor cover. In such embodiments, the disc serves to protect an interior portion of a sprocket or rotor from becoming damaged during storage or from becoming damaged when maintenance is performed on the motorcycle wheel and its associated components (e.g., a sprocket or a tire).

As yet another refinement, in some embodiments, the hollow annular structure of the sprocket and rotor cover defines a break in the annular structure. In other words, in those embodiments, the hollow annular structure does not comprise a continuous circular structure that can be slipped over a sprocket or rotor, but instead is comprised of a structure that can be wrapped around and then secured to a sprocket or rotor. In some embodiments that make use of a hollow annular structure including a break, the sprocket and rotor cover further comprises one or more fasteners that are used to secure the sprocket and rotor cover around a sprocket or rotor. In certain embodiments, the one or more fasteners comprises a strap and a pair of hook and loop fasteners.

Further provided, in some embodiments of the presently-disclosed subject matter, are methods of changing a sprocket on a rear motorcycle wheel that prevent or reduce the damage to an individual's hands or a sprocket itself when a sprocket is changed on a motorcycle. In some embodiments, a method of changing a sprocket is provided that comprises: removing the rear motorcycle wheel from a motorcycle; positioning a sprocket and rotor cover of the present invention around the sprocket that is secured to the rear motorcycle wheel; and removing the sprocket from the rear motorcycle wheel. In some embodiments, once the sprocket is removed from the rear motorcycle wheel, a second sprocket and rotor cover is then positioned around a second sprocket and the second sprocket is subsequently secured to the rear motorcycle wheel.

Still further provided, in some embodiments of the present invention, are methods of changing a tire on a motorcycle wheel that similarly prevent or reduce the damage to an individual's hands or the wheel of a motorcycle itself when a tire is changed on a motorcycle wheel. In some embodiments, a method of changing a tire on a motorcycle wheel is provided that comprises removing the motorcycle wheel from a motorcycle; positioning a sprocket and rotor cover of the present invention around the sprocket, the rotor, or both the sprocket and rotor secured to the motorcycle wheel; and removing the tire from the motorcycle wheel. In some embodiments, a second tire is then secured to the motorcycle wheel to thereby complete the changing of the tire in a manner that prevents or reduces injury to the wheel of the motorcycle or the individual changing the tire.

Further features and advantages of the presently-disclosed subject matter will become evident to those of ordinary skill in the art after a study of the description, Figures, and non-limiting Examples in this document.

### BRIEF DESCRIPTION OF THE DRAWINGS

FIG. 1 is a perspective view of an exemplary sprocket and rotor cover made in accordance with the presently-disclosed subject matter;

FIG. 2 is a cross-sectional view of a portion of the exemplary sprocket and rotor cover shown in FIG. 1, and showing a continuous groove in the inner surface of the sprocket and rotor cover for receiving the teeth of a sprocket;

FIG. 3 is a front view of another exemplary sprocket and rotor cover made in accordance with the presently-disclosed subject matter, showing a disc positioned in and covering one side of the centrally-disposed opening of the sprocket and rotor cover;

FIG. 4 is a perspective view of yet another exemplary sprocket and rotor cover made in accordance with the presently-disclosed subject matter, where the sprocket and rotor cover includes a plurality of ridges extending around the outer circumferential edge of the outer surface of the sprocket and rotor cover;

FIG. 5 is a cross-sectional view of a portion of the exemplary sprocket and rotor cover shown in FIG. 4, and showing a plurality of discrete notches in the inner surface of the sprocket and rotor cover for receiving the teeth of a sprocket;

FIGS. 6A and 6B are photographs showing an individual loosening a bolt on a motorcycle sprocket without (FIG. 6A) and with (FIG. 6B) the exemplary sprocket and rotor cover shown in FIG. 1 positioned on the sprocket and rotor of the motorcycle wheel;

FIGS. 7A and 7B are photographs showing an individual removing a sprocket from a motorcycle wheel without (FIG. 7A) and with (FIG. 7B) the exemplary sprocket and rotor cover shown in FIG. 1 positioned on the sprocket and rotor of the motorcycle wheel;

FIGS. 8A and 8B are photographs of a motorcycle wheel with tire tools positioned on the wheel for changing a tire, where the tire tools are placed on the motorcycle wheel without (FIG. 8A) and with (FIG. 8B) the exemplary sprocket and rotor cover shown in FIG. 1 positioned on the sprocket and rotor of the motorcycle wheel;

FIGS. 9A and 9B are photographs showing an individual using a tire tool to change a tire on a motorcycle wheel without (FIG. 9A) and with (FIG. 9B) the exemplary sprocket and rotor cover shown in FIG. 1 positioned on the sprocket and rotor of the motorcycle wheel; and

FIGS. 10A and 10B are photographs of a motorcycle wheel placed in storage without (FIG. 10A) and with (FIG. 10B) the exemplary sprocket and rotor cover shown in FIG. 1 positioned on the sprocket and rotor of the motorcycle wheel.

### DESCRIPTION OF EXEMPLARY EMBODIMENTS

The presently-disclosed subject matter includes sprocket and rotor covers as well as methods of using the same to change a sprocket or tire on a motorcycle wheel. In particular, the presently-disclosed subject matter includes sprocket and rotor covers for motorcycles that include a hollow annular structure and an annular receiving cavity such that the sprocket and rotor covers can be placed over a sprocket or rotor of a motorcycle to prevent injury to an individual's hands or to prevent damage to the sprocket or rotor itself.

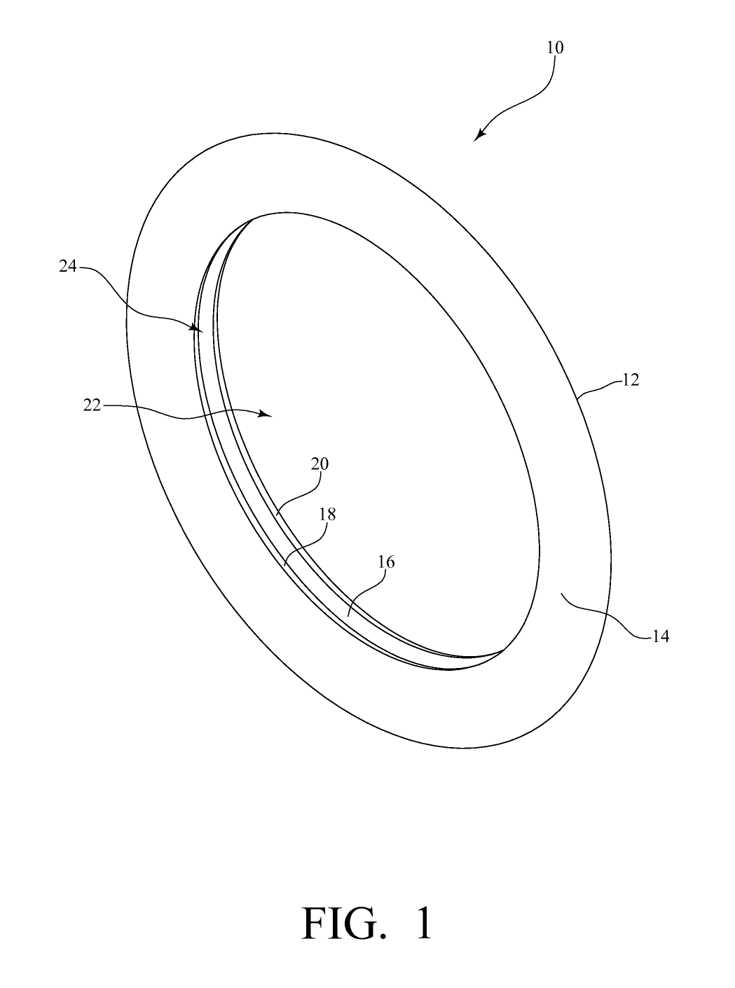

Referring first to FIG. 1, in one exemplary embodiment of a sprocket and rotor cover 10 made in accordance with the presently-disclosed subject matter, the sprocket and rotor cover 10 comprises a hollow annular structure 12 that includes an outer surface 14, an inner surface 16, and a pair of inner circumferential edges 18, 20 that define a centrally-disposed opening 22 of the hollow annular structure 12. Furthermore, as also shown in FIG. 1, the sprocket and rotor cover 10 includes an annular receiving cavity 24 that is defined between the inner surface 16 of the hollow annular structure 12.

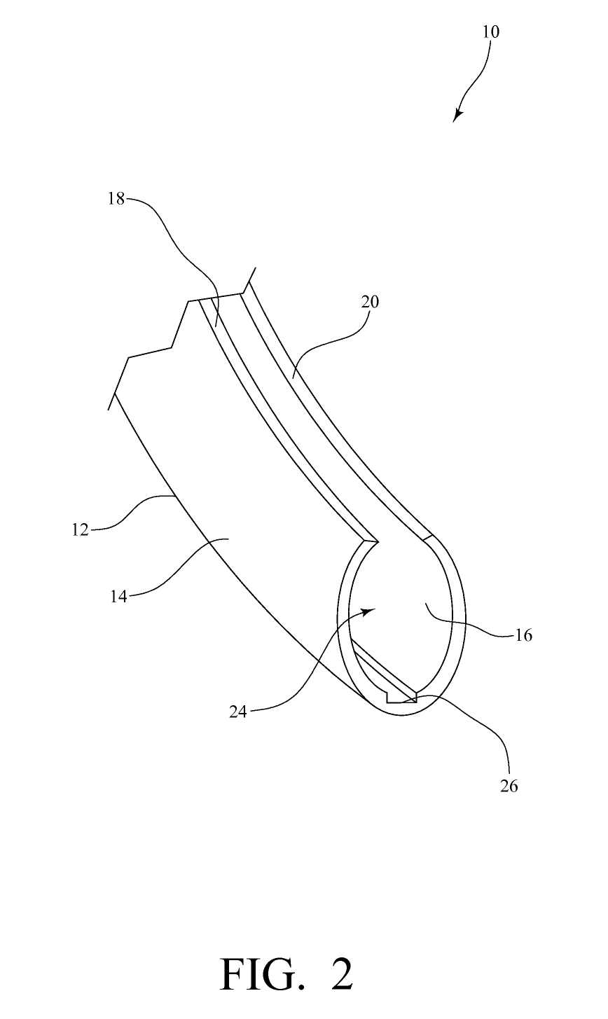

Referring now to FIG. 2, the cross-section of the hollow annular structure 12 is substantially U-shaped along any portion of the structure 12 such that annular receiving cavity 24 of the sprocket and rotor cover 10 has a shape that is adapted to fit around a sprocket or rotor of a motorcycle. It is believed that by fabricating the sprocket and rotor cover 10 to have a substantially U-shaped cross-section, the sprocket and rotor cover 10 can easily be fit onto any motorcycle sprocket or rotor, but yet will not extend down over the bolts used to attach a sprocket or rotor to the wheel of a motorcycle. Of course, the sprocket and rotor cover 10 can also be fabricated in a variety of sizes to fit around any size of sprocket or rotor, and can further be fabricated such that the cross-sectional shape of the sprocket and rotor cover varies as well. For example, in some embodiments, an exemplary sprocket and rotor cover can include a substantially square-shaped cross-section where the sprocket and rotor cover includes one or more squared corners.

In some embodiments, the inner surface 16 of the sprocket and rotor cover 10 further includes one or more notches in the inner surface 16 of the structure 12 for receiving the teeth of the sprocket. For example, as shown in FIG. 2, in some embodiments, the notches are in the form of a continuous groove 26 that extends around the circumference of the inner surface 16 to provide a sprocket and rotor cover 10 that can fit over any sprocket, regardless of the particular configuration of the teeth of the sprocket.

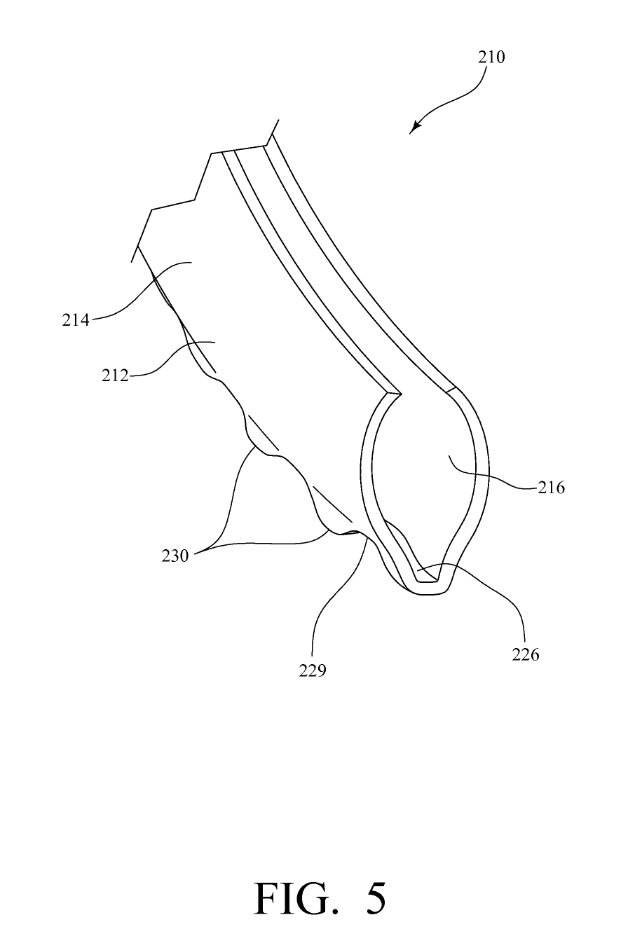

In other embodiments of an exemplary sprocket and rotor cover 210 of the presently-disclosed subject matter, and referring now to FIG. 5, the notches are comprised of a plurality of discrete notches 226 that extend around the circumference of the inner surface 216 of the hollow annular structure 212. In such embodiments, the discrete notches 226 are spaced a predetermined distance from each adjacent discrete notch 226 to allow each tooth of a sprocket to fit into a particular notch 226 and provide a sprocket and rotor cover 210 that can be securely positioned on a particular sprocket. Of course, the size and spacing of each discrete notch 226 can be tailored to fit the size and orientation of the teeth on a particular sprocket without departing from the spirit and scope of the subject matter described herein.

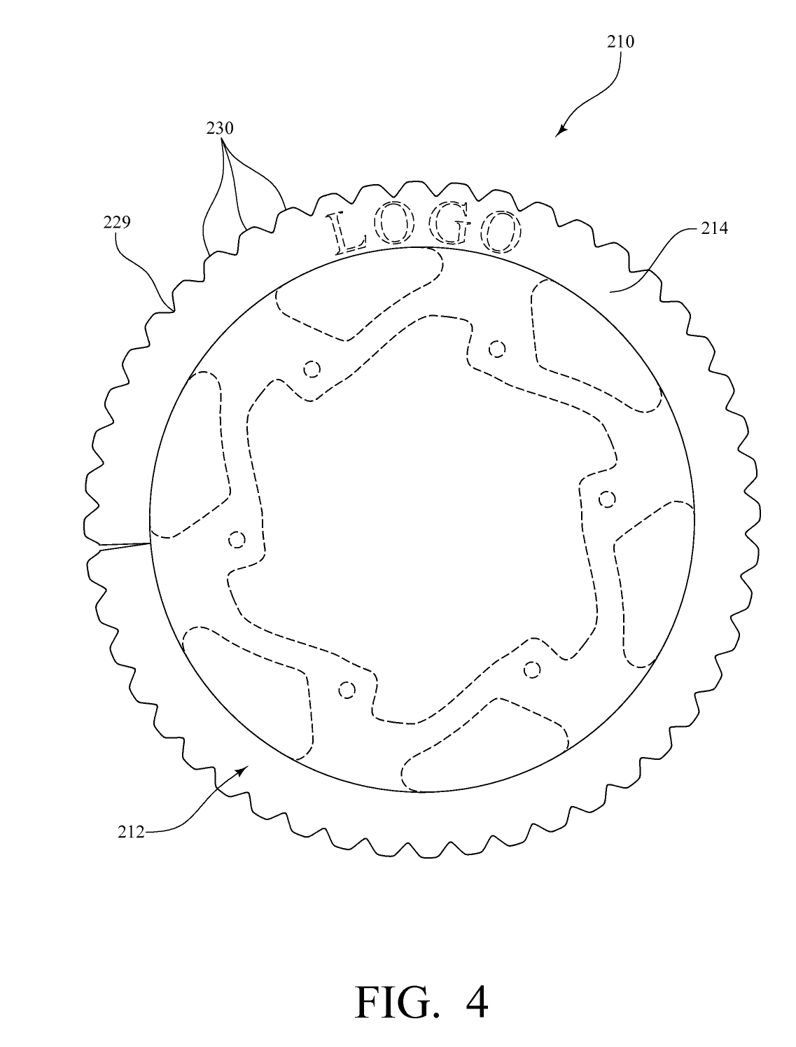

As a further refinement, and referring now to FIGS. 4 and 5, to provide a sprocket and rotor cover 210 that can be more securely positioned on a particular sprocket, the sprocket and rotor cover 210 further includes a plurality of ridges 230 that extend around the outer circumferential edge 229 of the outer surface 214 of the hollow annular structure 212. In certain embodiments of the sprocket and rotor cover 210, the position of the plurality of ridges 230 corresponds to the position of each discrete notch 226 such that, when the sprocket and rotor cover 210 is placed around a sprocket, the teeth of the sprocket extend into each notch 226 and are enveloped by the material comprising the ridge 230. In other embodiments, the position of the plurality of ridges 230 does not correspond to the position of each discrete notch 226. Rather, in those embodiments, the plurality of ridges extend around the outer circumferential edge to provide a means to more easily grasp the sprocket and rotor cover 210 while also providing an ornamental appearance.

Referring again to FIG. 1, the hollow annular structure 12 of the exemplary sprocket and rotor cover 10 is typically fabricated from a flexible yet durable material such that the sprocket and rotor cover 10 can be easily pulled over and fit to a particular sprocket or rotor, but can still provide a level of protection to an individual when they are changing a sprocket or tire on the wheel of a motorcycle. In some embodiments, the sprocket and rotor cover is made of a flexible rubber material that stretches to allow the sprocket and rotor cover 10 to be used with many different sizes of sprockets and rotors.

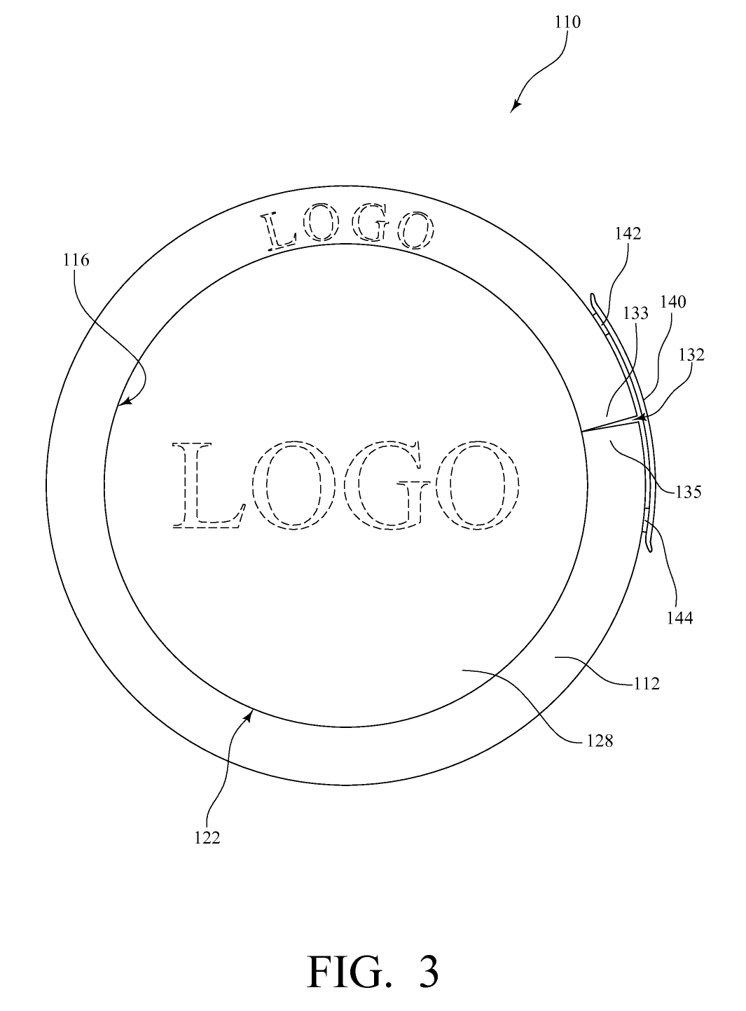

As another refinement, and referring now to FIG. 3, in some embodiments, another exemplary sprocket and rotor cover 110 further comprises a disc 128 that is positioned in the hollow annular structure 112, such that the disc 128 covers one side of the centrally-disposed opening 122 and covers the entire surface, including an interior portion, of the sprocket or rotor when the sprocket and rotor cover 110 is placed on the sprocket or rotor of a motorcycle wheel. Typically, the disc is fabricated from a sufficiently hard material, such as a plastic material, that can simply be tucked behind the inner surface 116 of the structure 112 when the cover 110 is placed on the rotor or sprocket. In this regard, the disc 128 thus provides an additional layer of protection to the sprocket or rotor, but also provides an additional layer of protection for the hands of individuals that may otherwise be injured during the changing of a sprocket or tire on a motorcycle.

Furthermore, the disc 128 can be used to display graphics, advertisements, or other logos, as shown in FIG. 3. In this regard, the disc 128 thus also provides a further opportunity to display the logo of a competitive motorcyclist's sponsor or the competitive motorcyclist's own custom name or number, which is of great importance in motorcycle racing. Additionally, competitive motorcycle racing individuals and teams may also find a display on the disc 128 beneficial, as it not only allows them to tell the wheel sets of different riders apart from one another, but also allows them to display the tooth size of a particular sprocket on the disc 128 in a large font.

As yet another refinement, in some embodiments, an exemplary sprocket and rotor cover of the presently-disclosed subject matter can further include a break to allow an exemplary sprocket and rotor cover to be more easily positioned around a sprocket or rotor of a motorcycle. For example, as shown in FIG. 3, in some embodiments, the sprocket and rotor cover 110 can include a break 132 in the cover 110 such that the cover 110 does not comprise a continuous circular structure that is slipped over a sprocket or rotor, but instead is comprised of a structure 112 that can be wrapped around the sprocket or rotor of a motorcycle. In such embodiments, the two ends 133,135 of the sprocket and rotor cover 110 can be secured together by using one or more fasteners, such as a strap 140 (e.g., a rubber strap) and a pair of hook and loop fasteners 142, 144 to provide a means to securely fasten the sprocket and rotor cover 110 around a sprocket or rotor. Of course, other fasteners, including straps with snaps and the like, can also be used to secure an exemplary sprocket and rotor cover around a sprocket and rotor in accordance with the presently-disclosed subject matter.

As noted, an exemplary sprocket and rotor cover of the presently-disclosed subject matter can advantageously be used to avoid a number of the problems and difficulties that frequently arise when an individual attempts to change a sprocket or rotor on a motorcycle wheel. In this regard, in some embodiments of the presently-disclosed subject matter, a method of changing a sprocket on a rear motorcycle wheel is provided that advantageously can be used to avoid (e.g., prevent) the injuries to an individual's hands or the damage to a sprocket or rotor that may otherwise occur when changing a sprocket on a motorcycle wheel. In some embodiments, a method of changing a sprocket on a rear motorcycle wheel is provided that includes the steps of: removing the rear motorcycle wheel from a motorcycle; positioning a sprocket and rotor cover of the presently-disclosed subject matter around the sprocket that is secured to the rear motorcycle wheel; and removing the sprocket from the rear motorcycle wheel. In some embodiments, once the sprocket is removed from the rear motorcycle wheel, a second sprocket and rotor cover is then positioned around a second sprocket and the second sprocket is subsequently secured to the rear motorcycle wheel. Of course, methods similar to those described herein for changing a sprocket can also be used to change a rotor on a motorcycle without departing from the spirit and scope of the presently-disclosed subject matter.

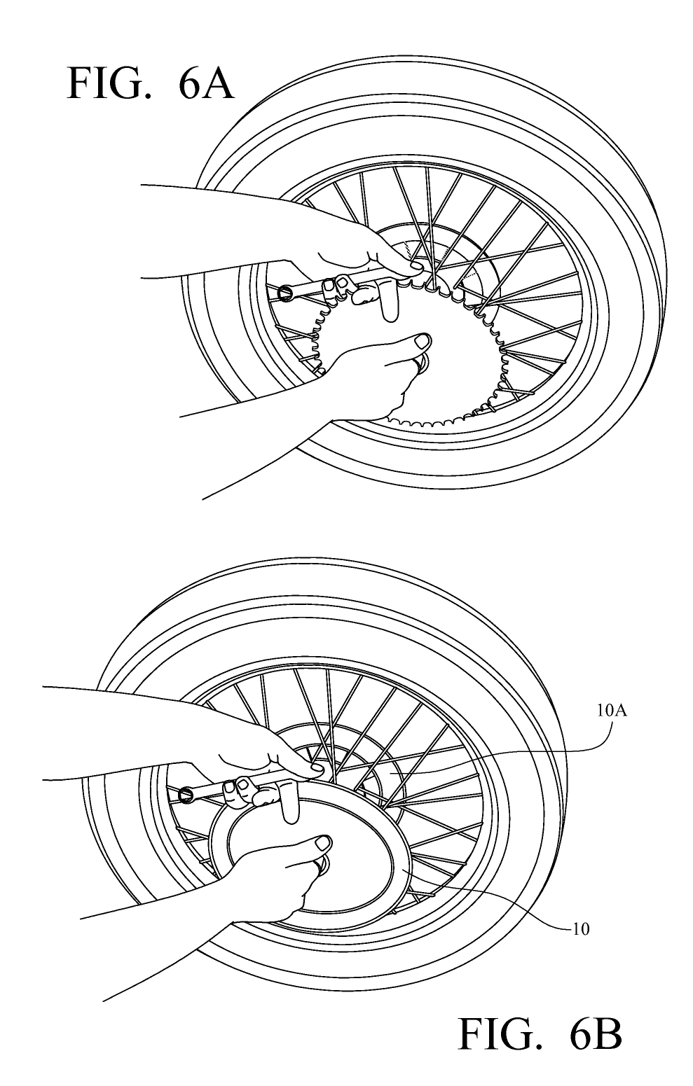

As one example of the problems and difficulties that frequently arise when an individual attempts to change a sprocket or rotor on a motorcycle wheel, as shown in FIGS. 6A and 6B, when loosing the bolts on a sprocket, a great deal of force must be applied in order to loosen the bolts. Frequently, applying this force causes the individual to injure his or her hands, such as by bringing their knuckles into contact with the teeth of the sprocket, as shown in FIG. 6A. By placing an exemplary sprocket and rotor cover 10 around the sprocket, however, such injury can be prevented as the sprocket and rotor cover 10 provides a barrier between the sprocket and the individual's hands, as shown in FIG. 6B. Furthermore, as also shown in FIG. 6B, when changing a sprocket on a motorcycle wheel, it is contemplated that an additional sprocket or rotor cover 10A, which is substantially identical to the sprocket and rotor cover 10 shown in FIG. 1, can be positioned on the rotor of the motorcycle wheel to prevent damage to the rotor if the individual changing the sprocket looses his grasp on the wheel and the wheel falls and contacts a surface.

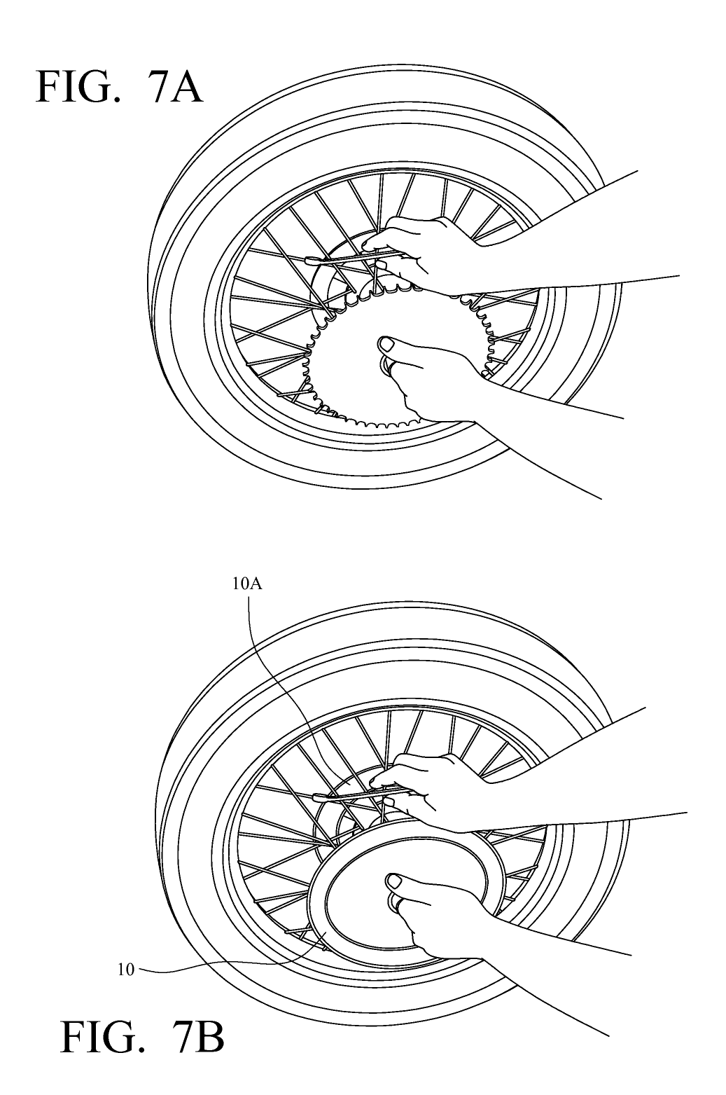

As another example of the advantageous results that may be achieved by using the exemplary sprocket and rotor cover 10, and referring now to FIGS. 7A and 7B, when removing a sprocket from a wheel, an individual will typically pull the sprocket off of the wheel with one hand, while applying force to the wheel with the other hand. By doing so, the individual will frequently and inadvertently bring the teeth of the sprocket into contact with the hand that is applying force to the wheel, as shown in FIG. 7A, thus resulting in injury to the hand. As shown in FIG. 7B, by utilizing the exemplary sprocket and rotor cover 10, however, the sprocket and rotor cover 10 envelops the teeth of the sprocket and prevents them from coming into contact with and injuring the hand of the individual removing the sprocket.

As also noted, an exemplary sprocket and rotor cover of the presently-disclosed subject matter can advantageously be used to avoid a number of the problems and difficulties that frequently arise when an individual also attempts to change a tire on a motorcycle wheel. In this regard, in some embodiments of the presently-disclosed subject matter, a method of changing a tire on a motorcycle wheel is provided that advantageously can be used to avoid (e.g., prevent) the injuries to an individual's hands or the damage to a sprocket or rotor that may otherwise occur when changing a tire on a motorcycle wheel. In some embodiments, a method of changing a tire on a motorcycle wheel is provided that comprises removing the motorcycle wheel from a motorcycle; positioning a sprocket and rotor cover of the present invention around the sprocket, the rotor, or both the sprocket and rotor that are secured to the motorcycle wheel; and removing the tire from the motorcycle wheel. In some embodiments, a second tire is then secured to the motorcycle wheel to thereby complete the changing of the tire in a manner that prevents or reduces injury to the wheel of the motorcycle or the individual changing the tire.

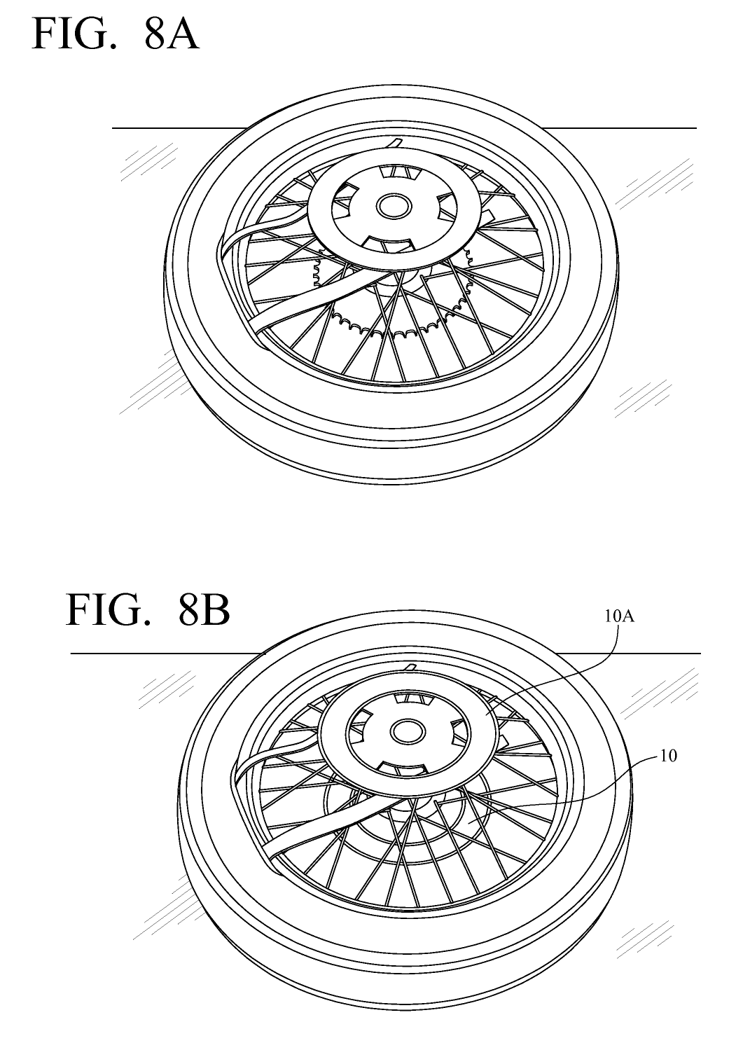

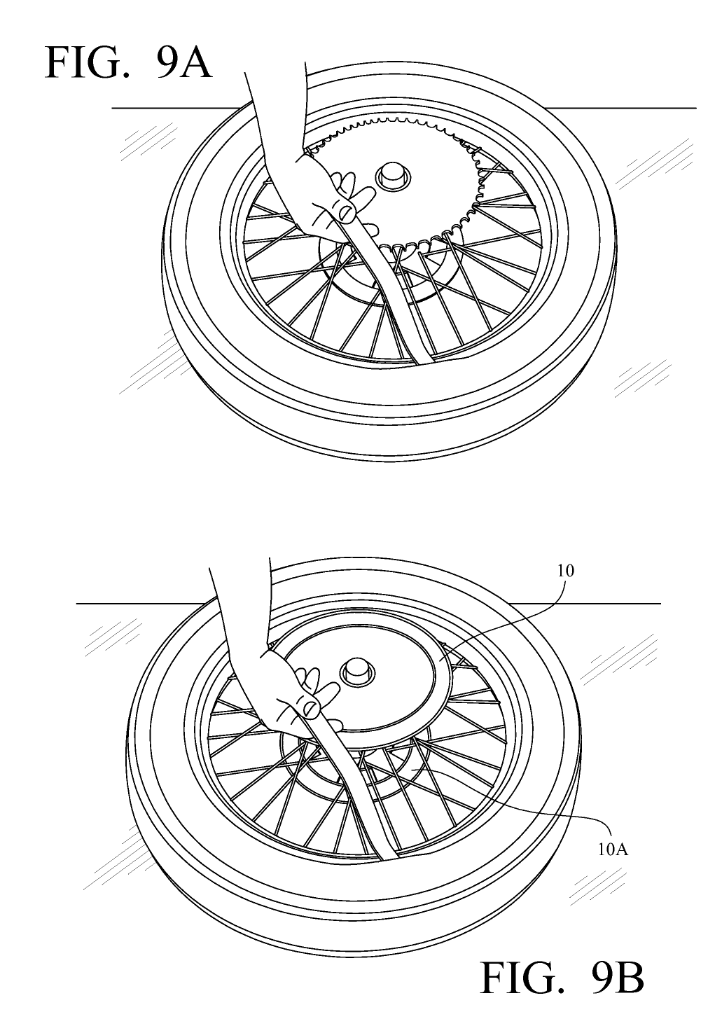

As an example of how an exemplary sprocket and rotor cover may be advantageously utilized to change a tire on a motorcycle, when changing a tire on a motorcycle wheel, individuals frequently lay the motorcycle wheel face down on the ground, as shown in FIGS. 8A and 8B. By laying the motorcycle wheel face down on the ground though, damage to the sprockets or rotors (e.g., scratches or dents) can be incurred. Furthermore, when the tire is actually pried from the rim of the motorcycle wheel, as shown in FIGS. 9A and 9B, a tire tool (e.g., a lever) must be used to pry the tire from the rim of the wheel. This can result in the tire tool slipping and then scratching or denting the surface of the sprocket or rotor. Positioning an exemplary sprocket or rotor cover 10, 10A around the sprocket or rotor of a motorcycle wheel overcomes these problems by covering the sprocket or rotor and preventing them from coming into direct contact with the ground or a tire tool.

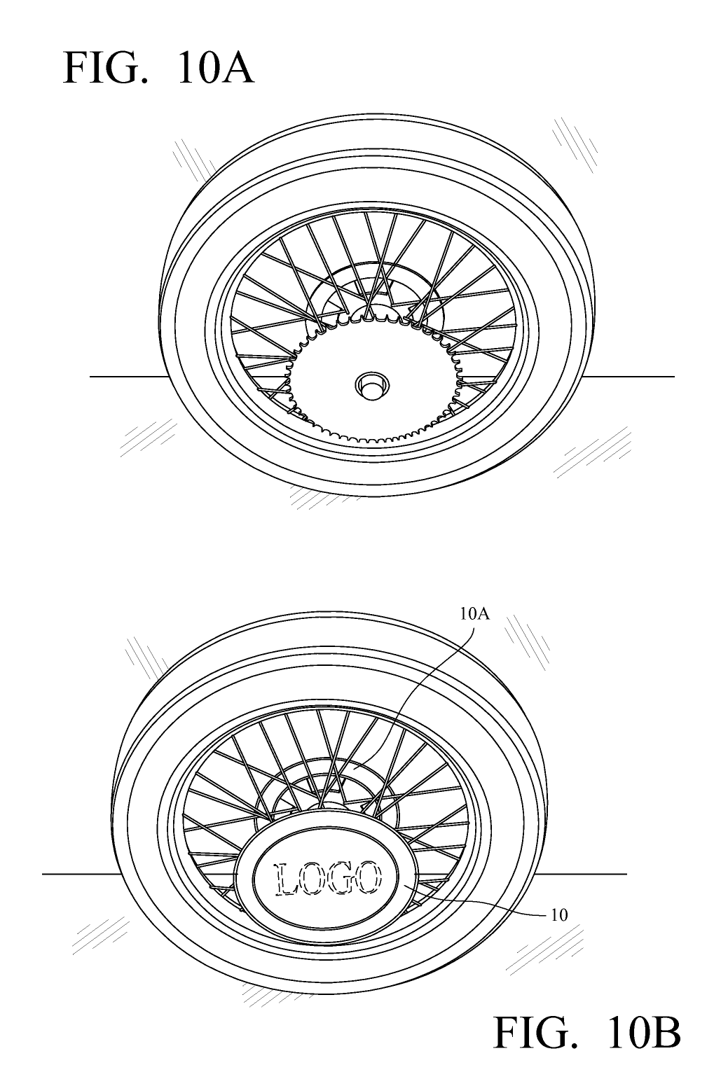

It is also contemplated that an exemplary sprocket and rotor cover can be used to protect the rotor and sprocket of a motorcycle wheel when the motorcycle wheel is placed into storage, as shown in FIGS. 10A and 10B. Placing a motorcycle wheel in storage frequently results in the wheels of a motorcycle becoming covered with dirt and other debris, as these storage areas are often garages or trailers. Additionally, when a plurality of motorcycle wheels are placed in storage, these wheels are frequently stacked on top of one another to save space. However, stacking the wheels on top of one another can bring the rotors and sprockets of the respective wheels into contact with one another and result in damage to the rotors and sprockets. Covering the rotors and sprockets with exemplary sprocket and rotor covers 10, 10A of the presently-disclosed subject matter prevents these issues from arising by not only providing a protective barrier over the sprocket or rotor, but also providing a barrier that will keep dirt and debris from collecting on the sprockets and rotors and therefore keep the bearings of the motorcycle wheel dirt- and debris-free for the next use of the wheel.

The sprocket and rotor covers of the presently-disclosed subject matter thus provide an effective means to prevent the damage to sprockets and rotors that may otherwise occur when changing a tire or sprocket, or simply placing a motorcycle wheel into storage. Furthermore, the sprocket and rotor covers sufficiently cover the portions of the sprockets or rotors, such as the teeth of the sprocket, that may otherwise cause injury to the hand of an individual when changing a tire or a sprocket on a motorcycle wheel.

One of ordinary skill in the art will recognize that additional embodiments are also possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A sprocket and rotor cover, comprising:
a hollow annular structure having a substantially U-shaped cross-section along any portion of the structure and including an outer surface, an inner surface, and a pair of inner circumferential edges defining a centrally-disposed opening of the hollow annular structure; and
an annular receiving cavity defined between the inner surface of the hollow annular structure, the annular receiving cavity having a shape adapted to fit around a sprocket or a rotor.

2. The sprocket and rotor cover of claim 1, wherein the inner surface of the hollow annular structure comprises one or more notches for receiving the teeth of the sprocket.

3. The sprocket and rotor cover of claim 2, wherein the one or more notches comprises a continuous groove extending around a circumference of the inner surface of the hollow annular structure.

4. The sprocket and rotor cover of claim 2, wherein the one or more notches comprises a plurality of discrete notches extending around a circumference of the inner surface of the hollow annular structure, each notch spaced at a predetermined distance from each adjacent notch.

5. The sprocket and rotor cover of claim 1, wherein an outer circumferential edge of the outer surface of the hollow annular structure includes a plurality of ridges extending around the outer circumferential edge, each ridge spaced at a predetermined distance from each adjacent ridge.

6. The sprocket and rotor cover of claim 5, wherein the inner surface of the hollow annular structure comprises a plurality of discrete notches extending around a circumference of the inner surface of the hollow annular structure with each notch spaced at a predetermined distance from each adjacent notch, and wherein the position of each ridge corresponds to the position of each discrete notch.

7. The sprocket and rotor cover of claim 1, further comprising a disc positioned such that the disc covers one side of the centrally-disposed opening.

8. The sprocket and rotor cover of claim 1, wherein the hollow annular structure defines a break in the annular structure, and wherein the sprocket and rotor cover further comprises one or more fasteners for securing the sprocket and rotor cover around a sprocket or rotor.

9. The sprocket and rotor cover of claim 8, wherein the one or more fasteners comprises a strap and a pair of hook and loop fasteners.

10. A method of changing a sprocket on a rear motorcycle wheel, comprising:
removing the rear motorcycle wheel from a motorcycle, the rear motorcycle wheel including a sprocket secured to the rear motorcycle wheel;
positioning a sprocket and rotor cover around the sprocket, the sprocket and rotor cover having:
a hollow annular structure having a substantially U-shaped cross-section along any portion of the structure and including an outer surface, an inner surface, and a pair of inner circumferential edges defining a centrally-disposed opening of the hollow annular structure; and
an annular receiving cavity defined between the inner surface of the hollow annular structure, the annular receiving cavity having a shape adapted to fit around a sprocket or a rotor; and
removing the sprocket from the rear motorcycle wheel.

11. The method of claim 10, further comprising the steps of:
positioning a second sprocket and rotor cover around a second sprocket; and
securing the second sprocket to the rear motorcycle wheel.

12. The method of claim 10, wherein the inner surface of the sprocket and rotor cover comprises one or more notches for receiving the teeth of the sprocket.

13. The method of claim 10, further comprising the step of positioning a disc in the centrally-disposed opening of the sprocket and rotor cover such that the disc covers one side of the centrally-disposed opening and an interior portion of one side of the sprocket.

14. The method of claim 10, wherein the hollow annular structure of the sprocket and rotor cover defines a break in the annular structure, and wherein the sprocket and rotor cover further comprises one or more fasteners for securing the sprocket and rotor cover around the sprocket.

15. The method of claim 14, wherein the one or more fasteners comprises a strap and a pair of hook and loop fasteners.

16. A method of changing a tire on a motorcycle wheel, comprising:
removing the motorcycle wheel from a motorcycle, the motorcycle wheel including a sprocket, a rotor, or both secured to the motorcycle wheel;
positioning a sprocket and rotor cover around at least one of the sprocket and the rotor of the motorcycle wheel, the sprocket and rotor cover having:
a hollow annular structure having a substantially U-shaped cross-section along any portion of the structure and including an outer surface, an inner surface, and a pair of inner circumferential edges defining a centrally-disposed opening of the hollow annular structure; and
an annular receiving cavity defined between the inner surface of the hollow annular structure, the annular receiving cavity having a shape adapted to fit around a sprocket or a rotor; and
removing the tire from the motorcycle wheel.

17. The method of claim 16, further comprising the steps of:
securing a second tire to the motorcycle wheel.

18. The method of claim 16, wherein the sprocket and rotor cover is positioned on a sprocket, and wherein the inner surface of the sprocket and rotor cover comprises one or more notches for receiving the teeth of the sprocket.

19. The method of claim 16, further comprising the step of positioning a disc in the centrally-disposed opening of the sprocket and rotor cover such that the disc covers one side of the centrally-disposed opening and an interior portion of one side of the sprocket or rotor.

20. The method of claim 16, wherein the hollow annular structure of the cover defines a break in the annular structure, and wherein the sprocket and rotor cover further comprises one or more fasteners for securing the sprocket and rotor cover around the sprocket, the rotor, or both the sprocket and rotor.
